(19) United States
(12) Patent Application Publication
(10) Pub. No.: US 2013/0238269 A1
(43) Pub. Date: Sep. 12, 2013

(54) APPARATUSES AND METHODS FOR DYNAMIC TRACKING AND COMPENSATION OF MAGNETIC NEAR FIELD

(71) Applicant: Hua Sheng, Clarksburg, MD (US)

(72) Inventor: Hua Sheng, Clarksburg, MD (US)

(73) Assignee: HILLCREST LABORATORIES, INC., Rockville, MD (US)

(21) Appl. No.: 13/885,251

(22) PCT Filed: Nov. 17, 2011
(86) PCT No.: PCT/US11/61171

§ 371 Date: May 14, 2013

Related U.S. Application Data
(60) Provisional application No. 61/414,582, filed on Nov. 17, 2010.

(51) Int. Cl. G01B 7/00

(52) U.S. Cl. CPC G01B 7/003
USPC 702/92

(57) ABSTRACT

A method for tracking dynamic near fields and correcting a magnetic field measured together with an angular position having an unknown yaw offset relative to a gravitational reference system includes calculating a magnetic field difference between a magnetic field based on the measured magnetic field and the angular position, and a previous total magnetic field, estimating current near fields to be a sum of previous near fields and a portion of the calculated magnetic field difference, computing a magnitude difference, and an angular difference between the measured magnetic field corrected using the estimated current near fields and a fixed vector, comparing the magnitude difference and the angle difference with noise, and if the current measured magnetic field is consistent with the previously tracked magnetic near fields, updating the angular position and correcting the measured magnetic field for the current near field effects using the updated angular position.

### RELATED APPLICATION

This application is related to, and claims priority from U.S. Provisional Patent Application Ser. No. 61/414,582, entitled “Dynamic Magnetic Near Field Tracking and Compensation”, filed on Nov. 17, 2010, the disclosures of which are incorporated here by reference.

### TECHNICAL FIELD

The present inventions generally relate to apparatuses and methods for tracking and compensating for time varying magnetic fields (near fields) with respect to an earth-fixed reference coordinate system in a system including a magnetometer and motion sensors.

### BACKGROUND

The increasingly popular and widespread mobile devices frequently include so-called nine-axis sensors which consist of a 3-axis gyroscope, a 3-D accelerometer and a 3-D magnetometer. The 3-D gyroscope measures angular velocities. The 3-D accelerometer measures linear acceleration. The magnetometer measures a local magnetic field vector (or a deviation thereof). In spite of their popularity, the foreseeable capabilities of these nine-axis sensors are not fully exploited due to the difficulty of calibrating and removing undesirable effects from the magnetometer measurements on one hand, and the practical impossibility to make a reliable estimate of the yaw angle using only the gyroscopes and the accelerometer.

A rigid body's (i.e., by rigid body designating any device to which the magnetometer and motion sensors are attached) 3-D angular position with respect to an Earth-fixed gravitational orthogonal reference system is uniquely defined. When a magnetometer and an accelerometer are used, it is convenient to define the gravitational reference system as having the positive Z-axis along gravity, the positive X-axis pointing to magnetic North and the positive Y-axis pointing East. The accelerometer senses gravity and other acceleration, while from magnetometer's measurement it can be inferred from the Earth's magnetic field that points to North (although it is known that the angle between the Earth's magnetic field and gravity may be different from 90°). This manner of defining the axis of a gravitational reference system is not intended to be limiting. Other definitions of an orthogonal right-hand reference system may be derived based on the two known directions, gravity and the magnetic North.

Motion sensors attached to the 3-D body measure its position (or change thereof) in a body reference system defined relative to the 3-D body. For example, as illustrated in FIG. 1 for an aircraft, without loss of generality, the body reference system has the positive X-axis pointing forward along the aircraft's longitudinal axis, the positive Y-axis is directed along the right wing and the positive Z-axis is determined considering a right-hand orthogonal reference system (right hand rule). If the aircraft flies horizontally, the positive Z-axis aligns to the gravitational system's Z-axis, along the gravity. While the roll and pitch in the gravitational reference system can be determined using a 3-D accelerometer and a 2 or 3-D rotational sensors attached to the body and based on the gravity's known direction (see, e.g., Liberty patents—U.S. Pat. Nos. 7,158,118, 7,262,760 and 7,414,611), the yaw angle in the gravitational reference system is more difficult to be estimated accurately, which makes it preferable to augment those readings with the Earth's magnetic field (or more precisely its orientation) from magnetometer measurements.

Based on Euler's theorem, the body reference system and the gravitational reference system (as two orthogonal right-hand coordinate systems) can be related by a sequence of rotations (not more than three) about coordinate axes, where successive rotations are about different axis. A sequence of such rotations is known as an Euler angle-axis sequence. Such a reference rotation sequence is illustrated in FIG. 2. The angles of these rotations are angular positions of the device in the gravitational reference system.

A 3-D magnetometer measures a 3-D magnetic field representing an overlap of a 3-D static magnetic field including geomagnetic field (e.g., Earth's magnetic field), hard- and soft-iron effects, and a 3-D dynamic near field due to external time-varying electro-magnetic fields. The measured magnetic field depends on the actual orientation of the magnetometer. If the hard-iron effects, soft-iron effects and dynamic near fields were zero, the locus of the measured magnetic field (as the magnetometer is oriented in different directions) would be a sphere of radius equal to the magnitude of the Earth's magnetic field. The non-zero hard- and soft-iron effects render the locus of the measured magnetic field to be an ellipsoid offset from the origin.

Hard-iron effect is produced by materials that exhibit a constant magnetic field in magnetometer's body coordinate system, thereby generating constant offsets of the components of the measured magnetic field. As long as the orientation and position of the sources of magnetic field due to the hard-iron effects relative to the magnetometer is constant, the corresponding offsets are also constant.

Unlike the hard-iron effect that yields a magnetic field overlapping the Earth's field, the soft-iron effect is the result of material that influences, or distorts, a magnetic field (such as, iron and nickel), but does not necessarily generate a magnetic field itself. Therefore, the soft-iron effect is a distortion of the measured field depending upon the location and characteristics of the material causing the effect relative to the magnetometer and to the Earth's magnetic field. Thus, soft-iron effects cannot be compensated with simple offsets, requiring a more complicated procedure. Parameters for compensating for the hard-iron effect and the soft-iron effect can be calibrated by sampling measurements from magnetometer at different orientations in a absence of time-varying magnetic near-field.

The magnetic near fields are dynamic distortions of a measured magnetic field due to time-varying magnetic fields. The time-varying magnetic field in earth-fixed coordinate system may significantly affect measurements of the magnetometer. Such magnetic near fields can be generated by an earphone, a speaker, a cell phone, a vacuum cleaner, etc. In absence of a reliable estimate for the yaw from three-axis accelerometer and three-axis rotational sensor (e.g., the yaw angle drift problem due to no observation on absolute yaw angle measurement), a magnetic near field compensated magnetometer's measurement can provide an important reference making it possible to correct the yaw angle drift.

Therefore, it would be desirable to provide devices, systems and methods that enable real-time reliable use of a magnetometer together with other motion sensors attached to a device for determining orientation of the device (i.e., angular positions including a yaw angle), while avoiding the afore-described problems and drawbacks.

### SUMMARY

Devices, systems and methods using concurrent measurements from a combination of sensors including a magnetometer yield a local 3-D magnetic field value and then a corrected value of a yaw angle of a 3-D body.

According to one exemplary embodiment, a method for tracking dynamic near fields and correcting a magnetic field measured together with an angular position in a body reference system having an unknown yaw offset relative to a gravitational reference system is provided. The method includes calculating a magnetic field difference between (1) a magnetic field in the gravitational reference system, evaluated based on the measured magnetic field and assuming that the angular position is accurate, and (2) a previous estimated total magnetic field including previous tracked near fields, in the gravitational reference system. The method further includes estimating current near fields to be a sum of the previous near fields and a portion of the calculated field difference. The method also includes computing a magnitude difference between magnitudes of a current estimated total magnetic field including the estimated current near-fields and the measured magnetic field, and an angular difference between (1) a first angle between the current estimated total magnetic field and a fixed vector in the gravitational reference system, and (2) a second angle between the measured magnetic field and the fixed vector expressed in the body reference system. The method further includes the magnitude difference and the angle difference with noise to determine whether the current measured magnetic field is consistent with the previously tracked magnetic near fields. The method further includes comparing the magnitude difference and the angle difference with noise to determine whether the current measured magnetic field is consistent with the previously tracked magnetic near fields. The method finally includes, if the comparing determines that the current measured magnetic field is consistent with the previously tracked magnetic near fields, updating (S450) the angular position using the current estimated total magnetic field, and correcting the measured magnetic field for the current near field effects using the updated angular position.

According to another exemplary embodiment, an apparatus configured to perform a method for tracking dynamic near fields and correcting a magnetic field measured together with an angular position in a body reference system having an unknown yaw offset relative to a gravitational reference system is provided. The apparatus includes an interface configured to receive the magnetic field and the angular position measured by a magnetometer and motion sensor attached to a device. The apparatus further includes a data processing unit configured (A) to calculate a field difference between (1) a magnetic field in the gravitational reference system, evaluated based on the measured magnetic field and assuming that the angular position is accurate, and (2) a previous estimated total magnetic field including previous tracked near fields, in the gravitational reference system, (B) to estimate current near fields to be a sum of the previous near fields and a portion of the calculated field difference, (C) to compute compute a magnitude difference between magnitudes of a current estimated total magnetic field including the estimated current near-fields and the measured magnetic field, and an angular difference between (1) a first angle between the current estimated total magnetic field and a fixed vector in the gravitational reference system, and (2) a second angle between the measured magnetic field and the fixed vector expressed in the body reference system, (D) to compare the magnitude difference and the angle difference with noise to determine whether the current measured magnetic field is consistent with the previously tracked magnetic near fields, and (E) if determined that the current measured magnetic field is consistent with the previously tracked magnetic near fields, to update the angular position using the current estimated total magnetic field, and to correct the measured magnetic field for the current near field effects using the updated angular position.

According to another exemplary embodiment, a computer readable medium storing executable codes which when executed by a processor make the processor execute a method of tracking for dynamic near fields and correcting a magnetic field measured together with an angular position in a body reference system having an unknown yaw offset relative to a gravitational reference system is provided. The method includes calculating a magnetic field difference between (1) a magnetic field in the gravitational reference system, evaluated based on the measured magnetic field and assuming that the angular position is accurate, and (2) a previous estimated total magnetic field including previous tracked near fields, in the gravitational reference system. The method further includes estimating current near fields to be a sum of the previous near fields and a portion of the calculated field difference. The method also includes computing a magnitude difference between magnitudes of a current estimated total magnetic field including the estimated current near-fields and the measured magnetic field, and an angular difference between (1) a first angle between the current estimated total magnetic field and a fixed vector in the gravitational reference system, and (2) a second angle between the measured magnetic field and the fixed vector expressed in the body reference system. The method further includes the magnitude difference and the angle difference with noise to determine whether the current measured magnetic field is consistent with the previously tracked magnetic near fields. The method further includes comparing the magnitude difference and the angle difference with noise to determine whether the current measured magnetic field is consistent with the previously tracked magnetic near fields. The method finally includes, if the comparing determines that the current measured magnetic field is consistent with the previously tracked magnetic near fields, updating (S450) the angular position using the current estimated total magnetic field, and correcting the measured magnetic field for the current near field effects using the updated angular position.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is an illustration of a 3-D body reference system;

FIG. 2 is an illustration of a transition from a gravitational reference system to a body reference system;

FIG. 3 is a block diagram of a sensing unit, according to an exemplary embodiment;

FIG. 4 is a block diagram of a method for tracking and compensating magnetic near fields, according to an exemplary embodiment;

FIG. 5 is a block diagram of a method for tracking and compensating for magnetic near fields, according to an exemplary embodiment; and

FIG. 6 is flow diagram of a method for calibrating a magnetometer using concurrent measurements of motion sensors and a magnetometer attached to a device, according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a sensing unit including motion sensors and a magnetometer attached to a rigid 3-D body (“the device”). However, the embodiments to be discussed next are not limited to these systems but may be used in other systems including a magnetometer or other sensor with similar properties.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

According to an exemplary embodiment illustrated in FIG. 3, a sensing unit 100 that may be attached to a device in order to monitor the device's orientation includes motion sensors 110 and a magnetometer 120 attached to the device's rigid body 101. Concurrent measurements performed by the motion sensors 110 and the magnetometer 120 yield signals sent to a data processing unit 130 via an interface 140. In FIG. 3, the data processing unit 130 is located on the rigid body 101. However, in an alternative embodiment, the data processing unit may be remote, signals from the magnetometer and the motion sensors being transmitted to the data processing unit by a transmitter located on the device. The data processing unit 130 includes at least one processor and performs calculations using calibration parameters to convert the received signals into measured quantities including a magnetic field.

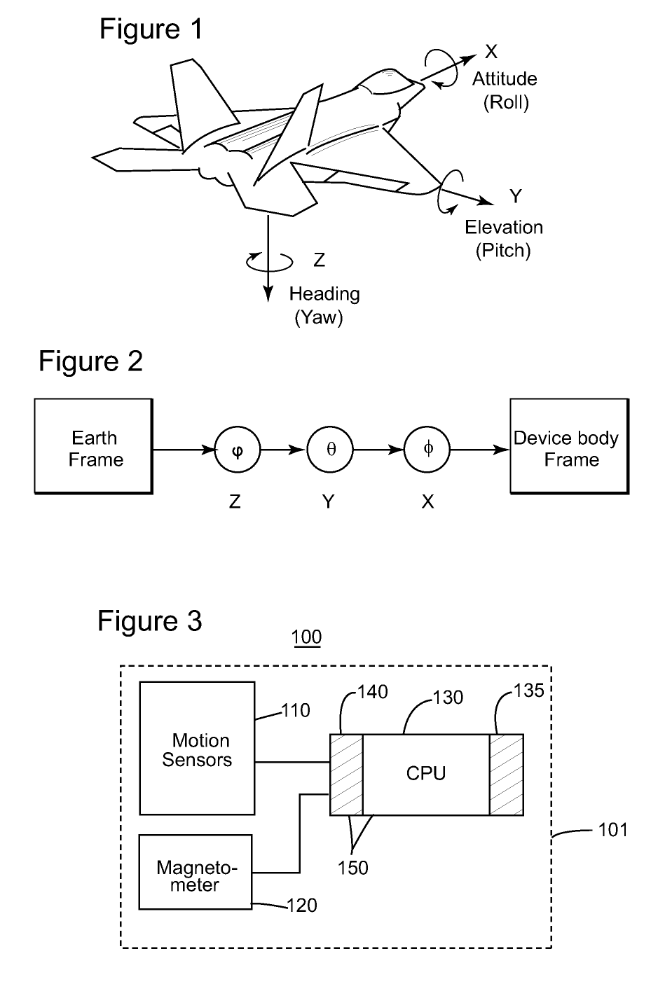

A body coordinate system may be defined relative to the device's body 101 (see, e.g., FIG. 1). The motion sensors 110 and the magnetometer 120 being fixedly attached to the rigid body 101, they generate signals related to observable (e.g., magnetic field, angular speed or linear acceleration) in the body reference system.

The interface 140 and the data processing unit 130 constitute a static magnetic field extracting unit 150. In FIG. 3, the static magnetic field extracting unit 150 is located on the rigid body 101. However, in order, for example, to determine body's orientation in a reference system independent from the device one has to be able to relate these measured quantities to an observer reference system. One may consider the observer's reference system to be an inertial reference frame, and the body reference system to be a non-inertial reference system. For an observer located on Earth, gravity provides one reference direction and magnetic North provides another. The observer's reference system may be defined relative to these directions. For example, a gravitational reference system may be defined to have z-axis along gravity, y-axis in a plane including gravity and the magnetic North direction, and, using the right hand rule, x-axis pointing towards East. However, this particular definition is not intended to be limiting. In the following description, the term “gravitational reference system” is used to describe a reference system defined using gravity and magnetic North.

The signals reflect quantities measured in the body reference system. These measurements in the body reference system are further processed by the data processing unit 130 to be converted into quantities corresponding to a gravitational reference system. For example, using rotation sensors and a 3-D accelerometer, a roll and pitch of the body reference system to a gravitational orthogonal reference system may be inferred. In order to accurately estimate a yaw angle of the device in the gravitational orthogonal reference system, determining the orientation of the Earth's magnetic field from the magnetic field measured in the body's reference system is necessary.

For determining the orientation of the Earth's magnetic field from the magnetic field measured in the body reference system, the data processing unit 130 corrects the measured 3-D magnetic field (which has been calculated from magnetometer signals ideally using calibration parameters) for hard-iron effects, soft-iron effects, misalignment and near fields using various parameters in a predetermined sequence of operations. Once the data processing unit 130 completes all these corrections, the resulting magnetic field may reasonable be assumed to be a local static magnetic field corresponding to the Earth's magnetic field. The Earth's magnetic field naturally points to North, slightly above or below a plane perpendicular to gravity, by a known angle called “dip angle”.

A toolkit of methods that may be performed in the system 100 is described below. The data processing 130 may be connected to a computer readable medium 135 storing executable codes which, when executed, make the system 100 to perform one or more of the methods related to extracting a local magnetic field.

Methods for dynamic tracking and compensating for the dynamic magnetic near fields affecting a magnetometer measurement by using the 3-D angular position estimate of the magnetometer with respect to the Earth-fixed gravitational reference system are provided. The 3-D angular position is not perfectly accurate and can include errors in roll, pitch angles, and at least yaw angle drift and/or an unknown offset. The magnetic field measurement compensated for dynamic near fields is useful for compass or 3-D angular position determination for a better yaw estimation. No conventional methods capable to achieve similar results have been found.

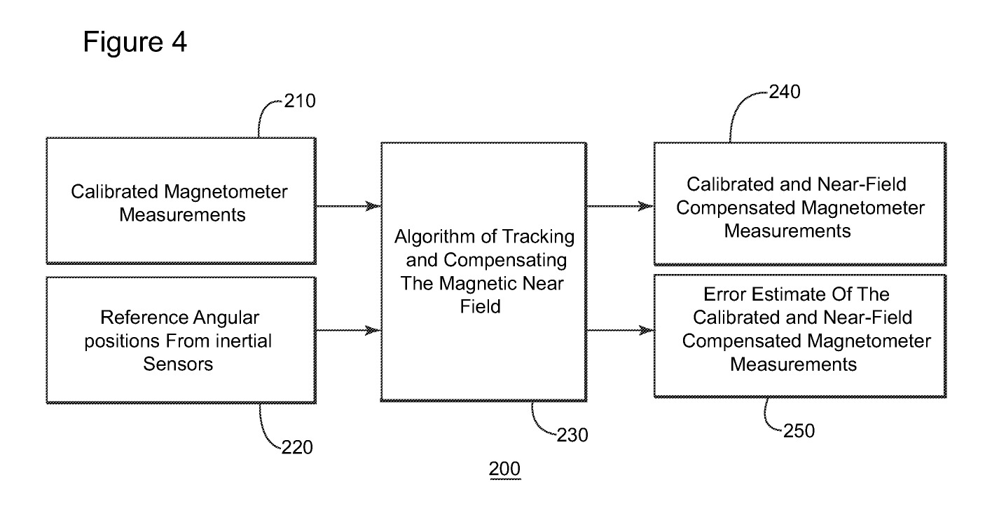

According to exemplary embodiments, FIG. 4 is a block diagram of a method 200 for tracking and compensating dynamic magnetic near fields, according to an exemplary embodiment. Measured magnetic field values calculated after completely calibrating the magnetometer 210 and reference angular positions inferred from concurrent measurements of body sensors 220 are input to an algorithm for tracking and compensating the dynamic magnetic near fields 230. The results of applying the algorithm 230 are local 3-D magnetic field values 240 (i.e., a calibrated and near field compensated magnetometer measurements) represented in device body coordinate system and an error estimate 250 associated with the static local 3-D magnetic field values 240.

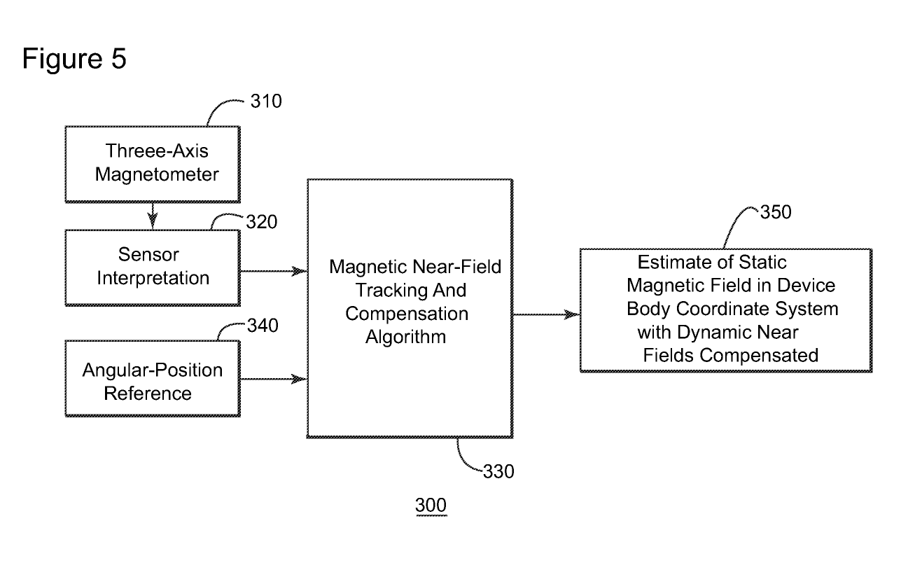

FIG. 5 is a block diagram of a method 300 for tracking and compensating for magnetic near fields, according to another exemplary embodiment. The block diagram of FIG. 5 emphasizes the data flow. A sensor block 310 including a 3-D magnetometer provides sensing signals to a sensor interpretation block 320. The sensor interpretation block 320 uses pre-calculated parameters to improve and convert the distorted sensor signals into standardized units, remove scale, skew, offset, and misalignment. Magnetic field values represented in device body coordinate system are output to the dynamic magnetic near field tracking and compensation algorithm 330. The angular positions of the device 340 with respect to an Earth-fixed gravitational reference system are also input to the algorithm 330. The angular positions are subject to a random roll and pitch angle error, and especially to a random yaw angle drift and/or an unknown offset. The algorithm 330 tracks changes due to the dynamic magnetic near fields, and compensates the input magnetic field value in device body reference system to output an estimate of static magnetic field in the device body coordinate system with dynamic near fields compensated. The algorithm 330 also uses the compensated magnetic measurement to correct the error in the inputted angular position, especially the yaw-angle error.

The following Table 1 is a list of notations used to explain the algorithms related to the methods for tracking and compensating near fields

TABLE 1

| Notation | Unit | Description |
|---|---|---|
| ₙ | | At time step tₙ; here a time step means a within a |
| | | time sequence but does not require a measuring |
| | | process occurring with a predetermined |
| | | frequency; at time step tₙ₊₁ it is performed a |
| | | measurement that follows a previous |
| | | measurement at time step tₙ |
| ⁱ | | Time step index |
| ^{E} | | Earth-fixed gravitational reference system |
| ^{D} | | The device's body reference system |
| × | | Matrix multiplication |
| ␣ | | Element-wise multiplication |
| • | | Dot product of two vectors |
| ⁻¹ | | Matrix inverse |
| ^{T} | | Matrix transpose |
| \|ν\| | | The magnitude of vector ν |
| ^{E}Hₜₒₜ | Gauss | the total magnetic field in Earth-fixed |
| | | gravitational reference system |
| ^{E}H₀ | Gauss | Known magnetic field vector in Earth-fixed |
| | | gravitational reference system, it is used for |
| | | establishing the reference Earth-fixed |
| | | gravitational reference system |
| ^{E}H_{NF} | Gauss | Magnetic near field disturbance in the Earth-fixed |
| | | gravitational reference system. |
| ^{E}Ĥ_{NF}_{ₙ} | Gauss | The estimate of dynamic ^{E}H_{NF} |
| ^{E}\tilde{H}_{NF}_{ₙ} | Gauss | The estimate of latest steady ^{E}Ĥ_{NF}_{ₙ} |
| ^{D}Bₙ | Gauss | The measurement vector of the total magnetic |
| | | field by the magnetometer in device's body |
| | | reference system at time step tₙ |
| ^{D}B₀ | Gauss | ^{E}H₀ in device's body reference system |
| ^{D}\hat{B}₀ | Gauss | The estimate of ^{D}B₀ |
| ^{D}B_{NF} | Gauss | The body system representation of ^{E}H_{NF} |
| ^{D}\hat{B}_{NF} | Gauss | The estimate of ^{D}B_{NF} |
| _{E}^{D}Rₙ | | The true rotation matrix brings Earth-fixed |
| | | gravitational reference system to device's body |
| | | reference system at time step tₙ |
| _{E}^{D}\hat{R}ₙ | | The estimated _{E}^{D}Rₙ from other sensors which is |
| | | subject to at least yaw angle drift and/or unknown |
| | | offset. |
| ^{E}A | Gauss | A virtual constant 3x1 vector in earth-fixed |
| | | reference system |
| ^{D}A | Gauss | The representation of ^{E}A in device body |
| | | reference system |
| ^{E}V | | Vector observation 3x2 array in Earth-fixed |
| | | gravitational reference system |
| ^{D}V | | Vector observation 3x2 array in device's body |
| | | reference system |
| ∠XY | Radian | $The angle between two vectors = {cos}^{- 1} ( \frac{X • Y}{\vert X \vert \cdot \vert Y \vert} )$ |
| ^{E}Ĥₜₒₜ | Gauss | The estimate of ^{E}Hₜₒₜ |
| rₙ₊₁ | Gauss | The difference between the ^{E}Ĥₜₒₜ_{ₙ₊₁} and ^{E}H₀ + |
| | | ^{E}Ĥ_{NF}_{ₙ} |
| ΔL | Gauss | The magnitude difference between measured |
| | | total magnetic field and estimated one using |
| | | ^{E}Ĥ_{NF}_{ₙ} |
| Δβ | Radian | The difference of angles within two vectors |
| | | between estimated using ^{E}Ĥ_{NF}_{ₙ} in Earth-fixed |
| | | gravitational reference system and measured/ |
| | | predicted in device's body reference system |
| sampleCount_ | | A persistent variable used to record how many |
| | | samples the magnetic near field are constant |
| k₁ | | A tunable constant, typically takes value between |
| | | 1 and 10 |
| k₂ | | A tunable constant, typically takes value between |
| | | 1 and 10 |
| Δ\tilde{β} | Radian | The difference of angles within two vectors |
| | | between estimated using ^{E}\tilde{H}_{NF}_{ₙ} in Earth-fixed |
| | | gravitational reference system and measured/ |
| | | predicted in the device's body reference system |
| Δ\tilde{L} | Gauss | The magnitude difference between measured |
| | | total magnetic field and estimated one using |
| | | ^{E}\tilde{H}_{NF}_{ₙ} |
| k₃ | | A tunable constant, typically takes value between |
| | | 1 and 10 |
| k₄ | | A tunable constant, typically takes value between |
| | | 1 and 10 |
| _{E}^{D}\tilde{R}ₙ | | Estimated _{E}^{D}Rₙ using ^{E}\tilde{H}_{NF}_{ₙ} |
| σ | Gauss | The noise standard deviation of magnetic field |
| | | strength measurement of magnetometer |
| σₓ | Gauss | The noise standard deviation of magnetic field |
| | | measurement of magnetometer along body x axis |
| α | | A single exponential smooth factor between 0 |
| | | and 1 |
| ^{E}\tilde{V} | | Vector observation 3x2 array in earth-fixed |
| | | reference system using ^{E}\tilde{H}_{NF}_{ₙ} |
| G | | A 3x3 matrix |
| u | | A 3x3 unitary matrix |
| s | | A 3x3 diagonal matrix with nonnegative diagonal |
| | | elements in decreasing order |
| ν | | A 3x3 unitary matrix |
| w | | A 3x3 diagonal matrix |
| ε_{yaw} | radian | the associated accuracy of yaw angle |
| | | computation using ^{D}\hat{B}₀ |
| ^{E}H₀ (1), | Gauss | The x and y component of ^{E}H₀, respectively |
| ^{E}H₀ (2) | | |

When the magnetic field in the Earth-fixed gravitational reference system is constant, the magnetic field measured by the magnetometer in the device's body reference system can be used to determine the 3-D orientation (angular position) of the device's body reference system with respect to Earth-fixed gravitational reference system. However, when the magnetic field in Earth-fixed gravitational reference system changes over time, the magnetometer measurement is significantly altered to reflect the combination of true 3-D orientation of the device and latest total local magnetic field including not only static part such as local geomagnetic field but also the dynamic part (the net change). Such time-dependent changes may be due to any near field disturbance such as earphones, speakers, cell phones, vacuum cleaner, etc.

If presence of a near field disturbance is not known when the magnetometer is used for orientation estimate or compass, then the estimated orientation or the North direction is inaccurate. Therefore, in order to practically use magnetometer measurements for determining 3-D orientation and compass, the magnetic near field tracking and compensation is desirable. Moreover, the angular position obtained from a combination including a 3-D accelerometer and a 3-D rotational sensor is affected by the yaw angle drift and/or an unknown offset because there is no direct observation of the absolute yaw angle of the device's body reference system with respect to the Earth-fixed gravitational reference system. The magnetic field value which is compensated for near fields corrects this deficiency, curing the yaw angle drift problem.

The calibrated magnetometer (including soft-iron and hard-iron effect calibration) measures:

^{D}Bₙ₊₁=(^{D}B₀+^{D}B_{NF})ₙ₊₁ Equation 1

where ^{D}B₀=_{E}^{D}R×^{E}H₀ Equation 2

and ^{D}B_{NF}=_{E}^{D}R×^{E}H_{NF} Equation 3

The method dynamically tracks ^{E}H_{NF} and uses it to estimate the ^{D}B_{NF}, then compensates it from ^{D}Bₙ to obtain ^{D}\hat{B}₀, the estimated ^{D}\hat{B}₀ is ready to be used for 3-D orientation measurement and compass. The methods may include the following steps.

Step 1: two 3×1 vectors are used to store the estimate of ^{E}Ĥ_{NF}ₙ and the latest estimate of steady ^{E}\tilde{H}_{NF}_{ₙ}, respectively.

Step 2: Construct a constant 3×1 vector in the Earth-fixed gravitational reference system

^{E}A=[0 0|^{E}H₀|]^{T} Equation 4

Step 3: Construct a vector of observations in Earth-fixed gravitational reference system

^{E}V=[^{E}H₀ ^{E}A] Equation 5

The following steps are executed for each time step.

Step 4: Compute a representation of ^{E}A in the device's body reference system using the angular position

^{D}Aₙ₊₁=_{E}^{D}\hat{R}ₙ₊₁×^{E}A Equation 6

By constructing ^{E}A in the manner indicated in Equation 4, the ^{D}Aₙ₊₁ is not affected by the yaw angle error in _{E}^{D}\hat{R}ₙ₊₁. The value of z axis of ^{E}A can be set to be any function of |^{E}H₀| to represent a relative weight of vector ^{E}A with respect to^{E}H₀.

Step 5: Compute the angle ∠^{D}Bₙ₊₁^{D}Aₙ₊₁ between ^{D}Bₙ₊₁ and ^{D}Aₙ₊₁

Step 6: Predict the total magnetic field (including the near fields) in Earth-fixed gravitational reference system:

^{E}Ĥₜₒₜ_{ₙ₊₁}=(_{E}^{D}\hat{R}ₙ₊₁)^{T}×^{D}Bₙ₊₁ Equation 7

Step 7: Compute the difference between the current total field estimate ^{E}Ĥₜₒₜ and the best estimate of the total field from the previous time step

rₙ₊₁=^{E}Ĥₜₒₜ_{ₙ₊₁}−(^{E}H₀+^{E}Ĥ_{NF}_{ₙ}) Equation 8

Step 8: Update the current near field estimate using, for example, a single exponential smooth filter.

^{E}Ĥ_{NF}_{ₙ₊₁}=^{E}Ĥ_{NF}_{ₙ}+α·rₙ₊₁ Equation 9

Step 9: Compute the total magnitude of ^{E}Ĥ_{NF}_{ₙ₊₁}+^{E}H₀, and take the difference between it and the magnitude of _{D}Bₙ₊₁. In other words, calculating a difference between an estimate of the total field and the measured field.

ΔLₙ₊₁=∥^{E}Ĥ_{NF}_{ₙ₊₁}+^{E}H₀|−|^{D}Bₙ₊₁∥ Equation 10

Step 10: Compute the angle ∠(^{E}Ĥ_{NF}_{ₙ₊₁}+^{E}H₀)^{E}A between ^{E}Ĥ_{NF}_{ₙ₊₁}+^{E}H₀ and ^{E}A.

Step 11: Compute the angle difference between ∠(^{E}Ĥ_{NF}_{ₙ₊₁}+^{E}H₀)^{E}A and ∠^{D}Bₙ₊₁^{D}Aₙ₋₁

Δβₙ₊₁=|∠(^{E}Ĥ_{NF}_{ₙ₊₁}+^{E}H₀)^{E}A−∠^{D}Bₙ₊₁^{D}Aₙ₊₁| Equation 11

Step 12: Evaluate if the magnetic near field is steady using, for example, the following exemplary embodiment.

$$if ( ( Δ {L}_{n + 1} <= {k}_{1} \cdot σ ) \&\& ( Δ {β}_{n + 1} <= {k}_{2} \cdot \frac{σ}{\vert {}_{}^{D}{B}{}_{n + 1}^{} \vert} ) ) \\ sampleCount\_ = sampleCount\_ + 1 ; \\ else \\ sampleCount\_ = 0 ; \\ end \qquad Code 1$$

where a variable of sampleCount_ is used to record how long the magnetic near field does not vary. Exemplarily, k₁ may be set to be 3, and k₂ may be set to be 4. σ is given by

σ=\sqrt{σₓ²+σ_{y}²+σ_{z}²} Equation 12

where σₓ, σ_{y}, and σ_{z} are the standard deviations of sample noise of a tri-axis magnetometer along the x-axis, y-axis, and z-axis, respectively. Those values can be predetermined from magnetometer manufacturer's specification sheet or static measurements in a controlled environment of constant magnetic field (e.g. manufacture calibration setup).

Step 13: Update ^{E}\tilde{H}_{NF}_{ₙ} to ^{E}Ĥ_{NF}_{ₙ} when sampleCount_ is larger than a predefined threshold (e.g., the threshold may be set to be equivalent to 1 second) and then reset sampleCount_{—} to be 0. An exemplary embodiment of step 13 is the following code

$$if ( sampleCount\_ > STABLE\_COUNT \_THRESHOLD ) \\ sampleCount\_ = 0 ; \\ {}_{}^{E}{\tilde{H}}{}_{{NF}_{n}}^{} = {}_{}^{E}{\hat{H}}{}_{{NF}_{n}}^{} ; \\ end \qquad Code 2$$

Step 14: Evaluate if a current sample is consistent with the latest estimated steady magnetic field by, for example, by performing the following sub-steps.

Sub-step 14.1: Compute angle difference between ∠(^{E}\tilde{H}_{NF}_{ₙ₊₁}+^{E}H₀)^{E}A and ∠^{D}Bₙ₊₁^{D}Aₙ₊₁

Δ\tilde{β}ₙ₊₁=|∠(^{E}Ĥ_{NF}_{ₙ₊₁}+^{E}H₀)^{E}A−∠^{D}Bₙ₊₁^{D}Aₙ₊₁| Equation 13

Sub-step 14.2: Compute the total magnitude of ^{E}Ĥ_{NF}_{ₙ₊₁}+^{E}H₀, and take the difference between it and the magnitude of ^{D}Bₙ₊₁

Δ\hat{L}ₙ₊₁=∥^{E}\tilde{H}_{NF}_{ₙ₊₁}+^{E}H₀|−|^{D}Bₙ₊₁∥ Equation 14

Sub-step 14.3: Compare the differences computed at 14.1 and 14.2 with pre-defined thresholds using, for example, the following code

$$if ( ( Δ {\tilde{L}}_{n + 1} <= {k}_{1} \cdot σ ) \&\& ( Δ {\tilde{β}}_{n + 1} <= {k}_{2} \cdot \frac{σ}{\vert {}_{}^{D}{B}{}_{n + 1}^{} \vert} ) ) \\ Yes , current sample is in the estimated steady \\ magnetic near field , go to step 15 and 16. \\ else \\ No . skip step 15 and 16 , current sample is not \\ near \text{-} field compensated , care needs to be taken \\ for orientation estimate or compass , wait for \\ next sample coming \\ end \qquad Code 3$$

where k₁ and k₂ can be set to be reasonably large to allow more samples to be included. Note that one option for the “else” step in Code 3 is to update the current model so that it better reflects the current magnetic field.

Step 15: If the result of step 14 is that current sample is consistent with the latest estimated steady magnetic field, then perform the following sub-steps.

Sub-step 15.1: Construct the vector observations in the Earth-fixed gravitational reference system using ^{E}\tilde{H}_{NF}_{ₙ₊₁}+^{E}H₀

^{E}\tilde{V}ₙ₊₁=[^{E}\tilde{H}_{NF}_{ₙ₊₁}+^{E}H₀ ^{E}A] Equation 15

Sub-step 15.2: Construct the vector observations in device's body reference system

^{E}Vₙ₊₁=[^{D}Bₙ₊₁ ^{D}Aₙ₊₁] Equation 16

Sub-step 15.3 Form the 3×3 matrix with the vector observations in both the device's body reference system and the Earth-fixed gravitational reference system:

G=^{D}Vₙ₊₁×(^{E}\tilde{V}ₙ₊₁)^{T} Equation 17

Sub-step 15.4: Solve the corrected _{E}^{D}\tilde{R}ₙ. This sub-step may be implemented using various different algorithms. An exemplary embodiment using a singular value decomposition (SVD) method is described below.

(1) Decompose G using SVD

[u s v]=SVD(G) Equation 18

(2) Compute the sign and construct w

$$w = [ \begin{matrix}1 & 0 & 0 \\ 0 & 1 & 0 \\ 0 & 0 & det ( u \times {v}^{T} )\end{matrix} ] \qquad Equation 19$$

(3) Compute _{E}^{E}\tilde{R}ₙ

_{E}^{E}\tilde{R}ₙ=u×w×v^{T} Equation 20

Step 16: Compute ^{D}\hat{B}₀ in which the magnetic near field is compensated

^{D}\hat{B}₀=_{E}^{D}\tilde{R}ₙ×^{E}H₀ Equation 21

Step 17: Estimate the error associated with a yaw angle determination using ^{D}\hat{B}₀

$${ɛ}_{yaw} = \sqrt{\begin{matrix}\frac{Δ {\tilde{L}}_{n + 1}^{2}}{{{}_{}^{E}{H}{}_{0}^{} ( 1 )}^{2} + {{}_{}^{E}{H}{}_{0}^{} ( 2 )}^{2}} + Δ {\tilde{β}}_{n + 1}^{2} + \\ \frac{{σ}^{2}}{3 \cdot ( {{}_{}^{E}{H}{}_{0}^{} ( 1 )}^{2} + {{}_{}^{E}{H}{}_{0}^{} ( 2 )}^{2} )}\end{matrix}} \qquad Equation 22$$

Parameters k₁ and k₂ may be set to be dynamic functions of the accuracy of magnetometer's calibration.

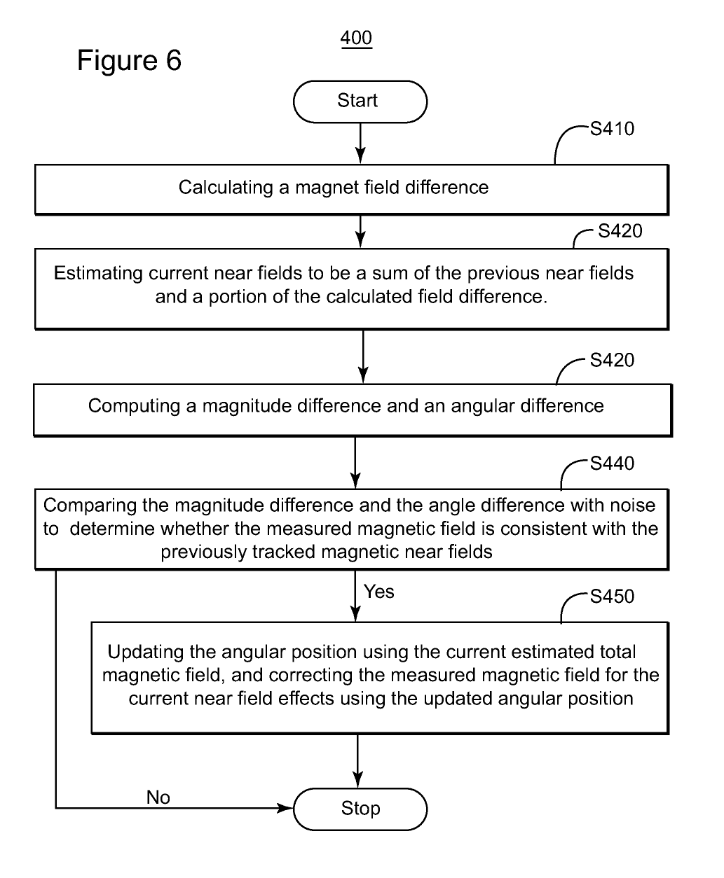

A flow diagram of a method 400 for tracking dynamic near fields and correcting a magnetic field measured together with an angular position in a body reference system having an unknown yaw offset relative to a gravitational reference system according to another embodiment is illustrated in FIG. 6. The method 400 includes calculating a magnetic field difference between (1) a magnetic field in the gravitational reference system, evaluated based on the measured magnetic field and assuming that the angular position is accurate, and (2) a previous estimated total magnetic field including previous tracked near fields, in the gravitational reference system, at S410.

Further the method 400 includes estimating current near fields to be a sum of the previous near fields and a portion of the calculated field difference, at S420. Then, the method 400 includes computing a magnitude difference between magnitudes of a current estimated total magnetic field including the estimated current near-fields and the measured magnetic field, and an angular difference between (1) a first angle between the current estimated total magnetic field and a fixed vector in the gravitational reference system, and (2) a second angle between the measured magnetic field and the fixed vector expressed in the body reference system, at S430.

The method 400 also includes comparing the magnitude difference and the angle difference with noise to determine whether the current measured magnetic field is consistent with the previously tracked magnetic near fields, at S440.

If the comparing determines that the current measured magnetic field is consistent with the previously tracked magnetic near fields (i.e., “YES” branch), the step S450 updating the angular position using the current estimated total magnetic field, and correcting the measured magnetic field for the current near field effects using the updated angular position.

The disclosed exemplary embodiments provide methods that may be part of a toolkit useable when a magnetometer is used in combination with other sensors to determine orientation of a device, and systems capable to use the toolkit. The methods may be embodied in a computer program product. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

1. A method for tracking dynamic near fields and correcting a magnetic field measured together with an angular position in a body reference system where the angular position has an unknown yaw offset relative to a gravitational reference system, the method comprising:
calculating a magnetic field difference between (1) a magnetic field in the gravitational reference system, evaluated based on the measured magnetic field and assuming that the angular position is accurate, and (2) a previous estimated total magnetic field including previous tracked near fields, in the gravitational reference system;
estimating current near fields to be a sum of the previous near fields and a portion of the calculated field difference;
computing a magnitude difference between magnitudes of a current estimated total magnetic field including the estimated current near-fields and the measured magnetic field, and an angular difference between (1) a first angle between the current estimated total magnetic field and a fixed vector in the gravitational reference system, and (2) a second angle between the measured magnetic field and the fixed vector expressed in the body reference system;
comparing the magnitude difference and the angle difference with noise to determine whether the current measured magnetic field is consistent with the previously tracked magnetic near fields; and
if the comparing determines that the current measured magnetic field is consistent with the previously tracked magnetic near fields, updating the angular position using the current estimated total magnetic field, and correcting the measured magnetic field for the current near field effects using the updated angular position.

2. The method of claim 1, wherein if the comparing determines that the current measured magnetic field not is consistent with the previously tracked magnetic near fields, the angular position is not updated and the measured magnetic field is not corrected for the current near field effects using the updated angular position.

3. The method of claim 1, wherein the angular position of the body is updated using a singular value decomposition based algorithm.

4. The method of claim 1, further comprising estimating an error associated with updating the yaw angle.

5. The method of claim 1, wherein the comparing is based on dynamic factors multiplying noise magnitudes.

6. The method of claim 1, wherein the comparison is performed relative to a predetermined number of measurements or measurements acquired over a predetermined time interval.

7. An apparatus configured to perform a method for tracking dynamic near fields and correcting a magnetic field measured together with an angular position in a body reference system having an unknown yaw offset relative to a gravitational reference system, the apparatus comprising:
an interface configured to receive the magnetic field and the angular position measured by a magnetometer and motion sensors attached to a device; and
a data processing unit configured
to calculate a magnetic field difference between (1) a magnetic field in the gravitational reference system, evaluated based on the measured magnetic field and assuming that the angular position is accurate, and (2) a previous estimated total magnetic field including previous tracked near fields, in the gravitational reference system;
to estimate current near fields to be a sum of the previous near fields and a portion of the calculated field difference;
to compute a magnitude difference between magnitudes of a current estimated total magnetic field including the estimated current near-fields and the measured magnetic field, and an angular difference between (1) a first angle between the current estimated total magnetic field and a fixed vector in the gravitational reference system, and (2) a second angle between the measured magnetic field and the fixed vector expressed in the body reference system;
to compare the magnitude difference and the angle difference with noise to determine whether the current measured magnetic field is consistent with the previously tracked magnetic near fields; and
if determined that the current measured magnetic field is consistent with the previously tracked magnetic near fields, to update the angular position using the current estimated total magnetic field, and to correct the measured magnetic field for the current near field effects using the updated angular position.

8. The apparatus of claim 7, wherein if determined that the current measured magnetic field not is consistent with the previously tracked magnetic near fields, the data processing unit is configured not to update the angular position and not to correct the measured magnetic field for the current near field effects.

9. The apparatus of claim 7, wherein the data processing unit is configured to update the angular position of the body a singular value decomposition based algorithm.

10. The apparatus of claim 7, wherein the data processing unit is further configured to estimate an error associated with updating the yaw angle.

11. The apparatus of claim 7, wherein the data processing unit is further configured to compare the magnitude difference and the angle difference with noise based on dynamic factors multiplying noise magnitudes.

12. The apparatus of claim 7, wherein the data processing unit is configured compare the magnitude difference and the angle difference relative to a predetermined number of measurements or measurements acquired over a predetermined time interval.

13. A computer readable medium storing executable codes which when executed by a processor make the processor execute a method of tracking for dynamic near fields and correcting a magnetic field measured together with an angular position in a body reference system having an unknown yaw offset relative to a gravitational reference system, the method comprising:
calculating a magnetic field difference between (1) a magnetic field in the gravitational reference system, evaluated based on the measured magnetic field and assuming that the angular position is accurate, and (2) a previous estimated total magnetic field including previous tracked near fields, in the gravitational reference system;
estimating current near fields to be a sum of the previous near fields and a portion of the calculated field difference;
computing a magnitude difference between magnitudes of a current estimated total magnetic field including the estimated current near-fields and the measured magnetic field, and an angular difference between (1) a first angle between the current estimated total magnetic field and a fixed vector in the gravitational reference system, and (2) a second angle between the measured magnetic field and the fixed vector expressed in the body reference system;
comparing the magnitude difference and the angle difference with noise to determine whether the current measured magnetic field is consistent with the previously tracked magnetic near fields; and
if the comparing determines that the current measured magnetic field is consistent with the previously tracked magnetic near fields, updating the angular position using the current estimated total magnetic field, and correcting the measured magnetic field for the current near field effects using the updated angular position.

14. The computer readable medium of claim 13, wherein if the comparing determines that the current measured magnetic field not is consistent with the previously tracked magnetic near fields, the angular position is not updated and the measured magnetic field is not corrected for the current near field effects using the updated angular position.

15. The computer readable medium of claim 13, wherein the angular position of the body is updated using a singular value decomposition based algorithm.

16. The computer readable medium of claim 13, wherein the method further comprises estimating an error associated with updating the yaw angle.

17. The computer readable medium of claim 13, wherein the comparing is based on dynamic factors multiplying noise magnitudes.

18. The computer readable medium of claim 13, wherein the comparison is performed relative to a predetermined number of measurements or measurements acquired over a predetermined time interval.
